(19) United States
(12) Patent Application Publication
(10) Pub. No.: US 2012/0119555 A1
(43) Pub. Date: May 17, 2012

(54) ANGLE ADJUSTMENT APPARATUS FOR VEHICLE SEAT

(75) Inventor: Macit AKTAS, Windsor (CA)

(73) Assignee: TOYOTA BOSHOKU KABUSHIKI KAISHA, Aichi-ken (JP)

(21) Appl. No.: 12/948,288

(22) Filed: Nov. 17, 2010

(51) Int. Cl. B60N 2/235

(52) U.S. Cl. 297/366

(57) ABSTRACT

An angle adjustment apparatus for a vehicle seat angle-adjustably connecting a first seat member and a second seat member of the vehicle seat has a first member attached to the first seat member, a second member attached to the second seat member and rotatably mounted to the first member, a lock member axially movably provided between the first member and the second member, and a movement mechanism that axially moves the lock member relative to the first member. The second member is provided with a rotation regulation portion that allows the lock member to axially move and regulates the lock member from circumferentially moving. The first member has a plurality of internal teeth formed in an annular-shaped internal peripheral surface. The lock member has an external peripheral surface facing substantially externally in a radial direction and facing the internal peripheral surface of the first member, and a plurality of external teeth formed in the external peripheral surface to be axially moved relative to and engaged with the internal teeth of the first member.

### BACKGROUND OF THE INVENTION

1. Field of the Invention

The present invention relates to an angle adjustment apparatus for a vehicle seat, the apparatus angle-adjustably connecting a first seat member and a second seat member of the vehicle seat.

2. Description of Related Art

An angle adjustment apparatus is a recliner that angle-adjustably connects a seat back to a seat cushion, for example (see Related Art 1). A conventional recliner has an arm plate provided to a seat back, a base plate provided to a seat cushion, a slider axially movably provided between the arm plate and the base plate, and a movement mechanism axially moving the slider relative to the arm plate.

The arm plate has teeth on a surface facing the slider. The slider is provided with teeth on a surface facing the arm plate, the teeth being engaged with the teeth of the arm plate. The movement mechanism has an axial member inserted into the slider, and a lever connected to the axial member. A groove is formed in the axial member, and a pin provided to the slider is inserted into the groove. The groove axially moves the pin by axially rotating the axial member with the lever. Thus, the slider axially moves with respect to the axial member, and the teeth of the arm plate and the teeth of the slider come close or are spaced apart from each other.
Related Art 1: U.S. Pat. No. 5,516,198

The teeth of the slider and the teeth of the arm plate, however, extend radially. Therefore, the interval of the teeth is large on the outer side of the radial direction, while it is small on the center side of the radial direction. Since the interval of the teeth is small on the center side of the radial direction, it is not easy to accurately form the interval of the teeth. Thus, an angle adjustment for a vehicle seat in which teeth can be formed accurately has been required in a type having teeth that can be engaged with each other in the axial direction.

### SUMMARY OF THE INVENTION

In view of the above, the present invention provides an angle adjustment apparatus for a vehicle seat. An aspect of the present invention provides an angle adjustment apparatus for a vehicle seat, angle-adjustably connecting a first seat member and a second seat member of the vehicle seat, that includes a first member attached to the first seat member; a second member attached to the second seat member and rotatably mounted to the first member; a lock member axially movably provided between the first member and the second member; and a movement mechanism that axially moves the lock member relative to the first member. The second member is provided with a rotation regulation portion that allows the lock member to axially move and regulates the lock member from circumferentially moving. The first member has a plurality of internal teeth formed in an annular-shaped internal peripheral surface. The lock member has an external peripheral surface facing substantially externally in the radial direction and facing the internal peripheral surface of the first member, and a plurality of external teeth formed in the external peripheral surface to be axially moved relative to and engaged with the internal teeth of the first member.

Accordingly, since the external teeth are formed in the external peripheral surface of the lock member facing substantially externally in the radial direction, each of the external teeth extends axially. Thus, the interval of the external teeth is almost unchanged over the entire length, and the interval of the teeth is not narrow (small) on the center side of the radial direction, differently from, for example, a case of teeth that extend radially. Likewise, since the internal teeth of the first member extend substantially axially, the interval of the internal teeth is not greatly changed over the entire length. Accordingly, the external teeth of the lock member and the internal teeth of the first member can be formed accurately.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 is a perspective view of a vehicle seat;

FIG. 2 is a perspective view of an angle adjustment apparatus;

FIG. 3 is an exploded perspective view of the angle adjustment apparatus;

FIG. 4 is an exploded perspective view of the angle adjustment apparatus;

FIG. 5 is a cross-sectional fragmentary view of the angle adjustment apparatus in a locked state taken along line V-V of FIG. 2;

FIG. 6 is a perspective view of a second member and a lock member;

FIG. 7 is a perspective view of a part of a first member and the lock member;

FIG. 8 is a partial perspective view of the lock member;

FIG. 9 is a cross-sectional fragmentary view taken along line IX-IX of FIG. 7;

FIG. 10 is a cross-sectional fragmentary view taken along line X-X of FIG. 7;

FIG. 11 illustrates a schematic configuration of a forming die and the lock member showing a forming process of the lock member; and

FIG. 12 illustrates a schematic configuration of a forming die and a comparative lock member showing a forming process of a comparative lock member.

### DETAILED DESCRIPTION OF PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

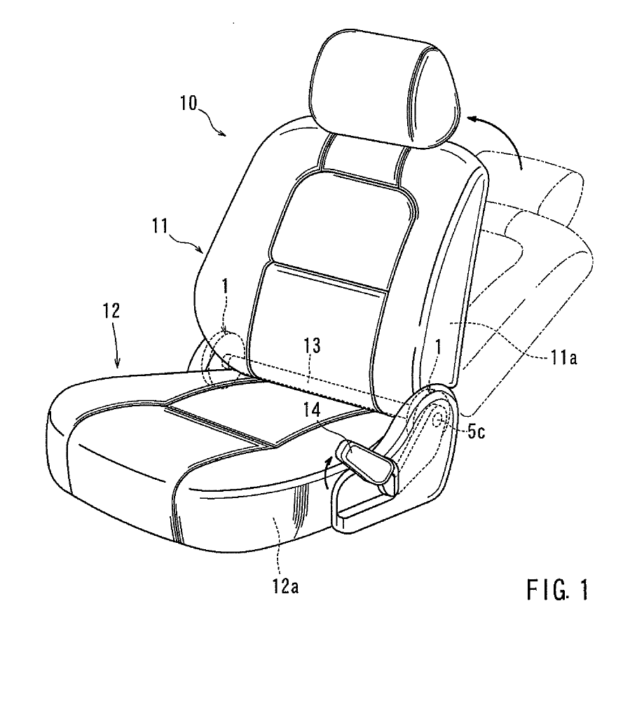

An embodiment of the present invention is explained with reference to FIGS. 1 to 12. As shown in FIG. 1, a vehicle seat 10 is a seat mounted to a vehicle and the like. The vehicle seat 10 has a seat back 11, a seat cushion 12, and a pair of angle adjustment apparatuses (recliners) 1. The angle adjustment apparatuses 1 angle-adjustably connect the seat back 11 and the seat cushion 12. The seat back 11 has a first seat member (back frame) 11a extending along a side surface of the seat back 11. The seat cushion 12 has a second seat member (cushion frame) 12a extending along a side surface of the seat cushion 12.

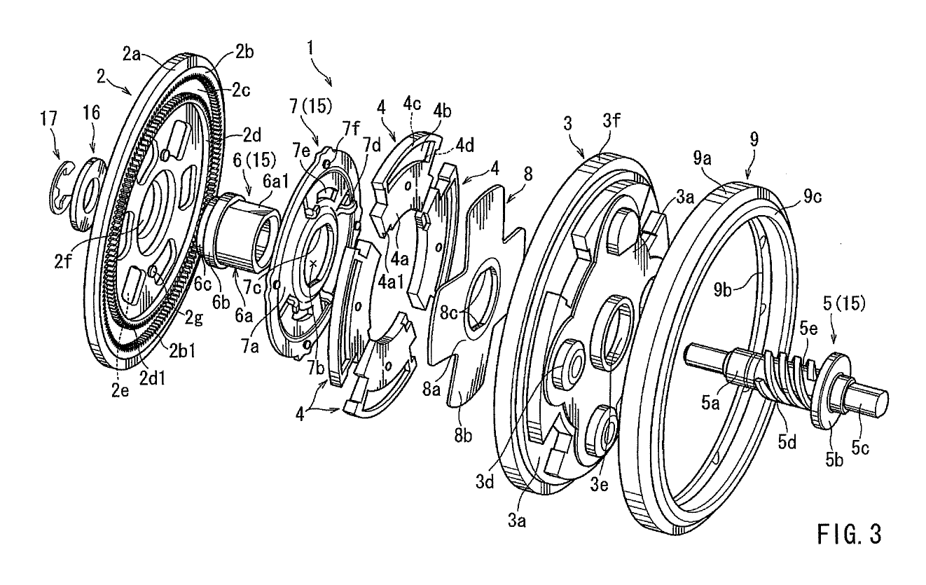

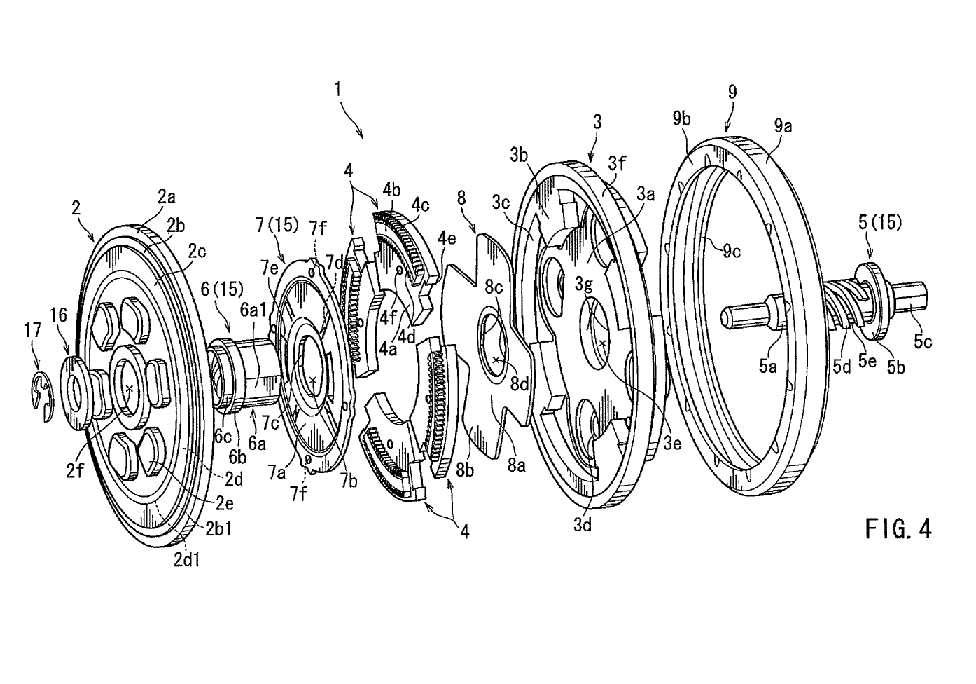

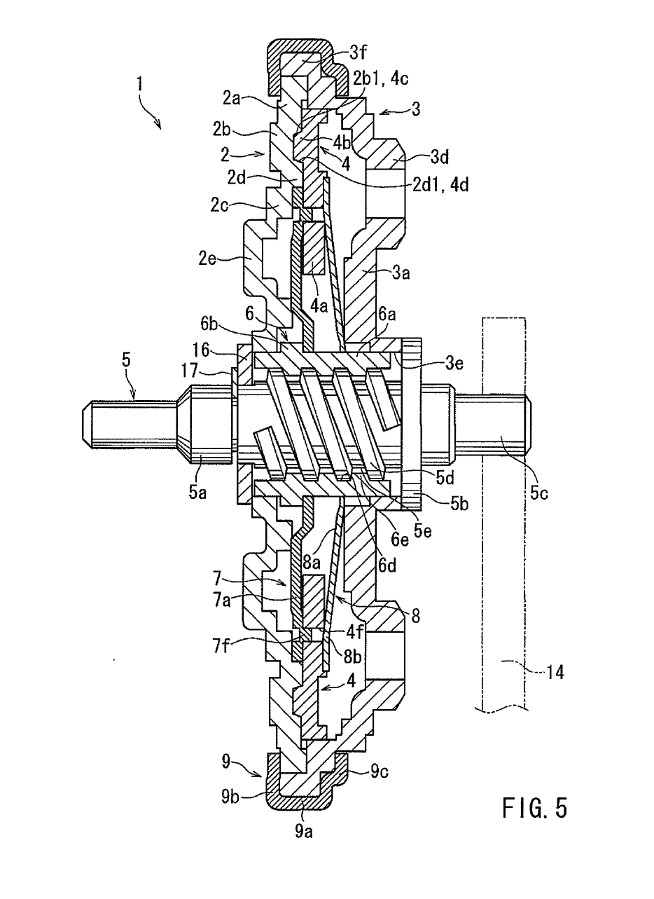

As shown in FIGS. 3 and 4, the angle adjustment apparatus 1 has a first member (ratchet) 2, a second member (guide member) 3, and a lock member (pole) 4. The first member 2 and the second member 3 have a circular plate shape. The first member 2 is integrally provided with a ring-shaped flange 2a, a ring-shaped ring main body 2b, and a plate-shaped plate main body 2c. The flange 2a is positioned along an external periphery of the first member 2; the ring main body 2b is positioned on the internal periphery side of the flange 2a; and the plate main body 2c is positioned on the internal periphery side of the ring main body 2b. The flange 2a is rotatably retained by the second member 3 as shown in FIG. 5.

As shown in FIGS. 3 and 4, the ring main body 2b is provided to the flange 2a in an end portion of the axial direction on the center side of the radial direction. The ring main body 2b has an annular shape, and has an internal peripheral surface on the center side of the radial direction. The internal peripheral surface has an annular shape, and substantially faces the center of the axial direction. A plurality of internal teeth 2b1 are formed in the internal peripheral surface at the same interval. Each of the internal teeth 2b1 extends axially.

As shown in FIGS. 3 and 4, the plate main body 2c is provided to the ring main body 2b in an end portion of the axial direction on the center side of the radial direction. An annular portion 2d is formed in a surface of the plate main body 2c facing the second member 3. The annular portion 2d projects toward the second member 3 and extends annularly. The external peripheral surface on the outer side of the radial direction of the annular portion 2d faces substantially externally in the axial direction. A plurality of external teeth 2d1 are formed in the external peripheral surface at the same interval. Each of the external teeth 2d1 extends axially.

As shown in FIGS. 3 and 4, a plurality of projection pins 2g projecting toward a controlling plate 7 are formed in a surface of the plate main body 2c facing the second member 3. The projection pins 2g can be inserted into elongated holes 7e formed in the controlling plate 7 or contact the controlling plate 7, depending on the relative angle between the controlling plate 7 and the first member 2. When the projection pins 2g can be inserted into the elongated holes 7e, the controlling plate 7 and the lock member 4 move toward the first member 2 so as to allow the lock member 4 to be engaged with the first member 2. On the other hand, when the projection pins 2g contact the controlling plate 7 without being inserted into the elongated holes 7e, the lock member 4 is regulated from moving toward the first member 2 by the controlling plate 7 so as not to allow the lock member 4 to be engaged with the first member 2.

As shown in FIGS. 3 and 4, a plurality of attachment portions 2e are provided in a surface of the plate main body 2c that is opposite to the second member 3. The attachment portions 2e project in a direction away from the second member 3, and are attached to the first seat member 11a shown in FIG. 1 by welding and the like. A hole 2f is provided at the center of the plate main body 2c, the hole 2f penetrating the plate main body 2c in a thickness direction.

The second member 3 is integrally provided with a main body 3a and a flange 3f as shown in FIGS. 4 and 5. The main body 3a has a circular plate shape, and the flange 3f is provided along an external periphery of the main body 3a. A plurality of projections 3d are provided in a surface of the main body 3a that is opposite to the first member 2. The projections 3d project in a direction away from the first member 2, and are attached to the second seat member 12a shown in FIG. 1 by welding and the like. A hole 3e is provided at the center of the main body 3a, the hole 3e penetrating the main body 3a in a thickness direction.

The flange 3f extends from an end portion of the axial direction of the main body 3a to the outer side of the radial direction as shown in FIGS. 4 and 5. The flange 3f has a ring shape, and the first member 2 is slidably and rotatably provided to an internal periphery of the flange 3f. A plurality of rotation regulation portions 3b and recesses 3c are alternately provided along the internal periphery of the flange 3f. The rotation regulation portions 3b project from the flange 3f toward the center of the radial direction. The recess 3c is provided between the rotation regulation portions 3b, and the lock member 4 is provided in the recess 3c.

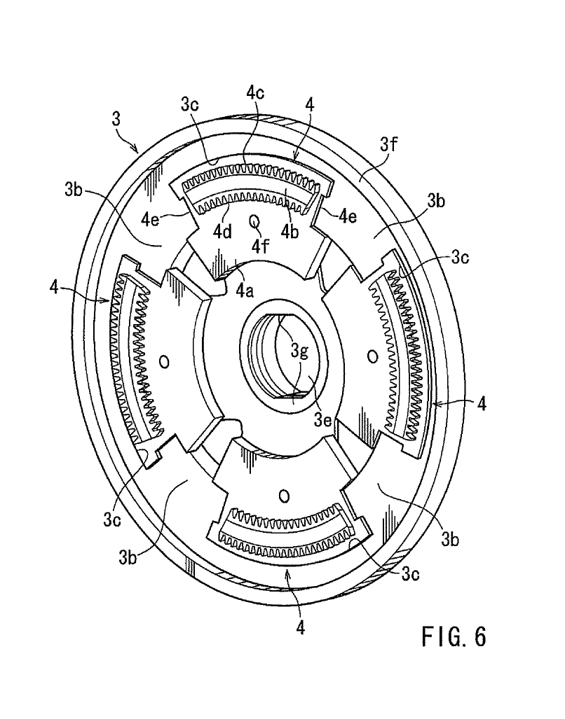

The lock member 4 is integrally provided with a lock main body 4a that is substantially fan-shaped; and a projection 4b that projects from the lock main body 4a toward the first member 2, as shown in FIGS. 4 and 6. The lock main body 4a is provided in the recess 3c of the second member 3, and both side edges 4e of the lock main body 4a are adjacent to the rotation regulation portions 3b. Thus, the lock member 4 is attached so as to be regulated from circumferentially moving and be axially movable with respect to the second member 3.

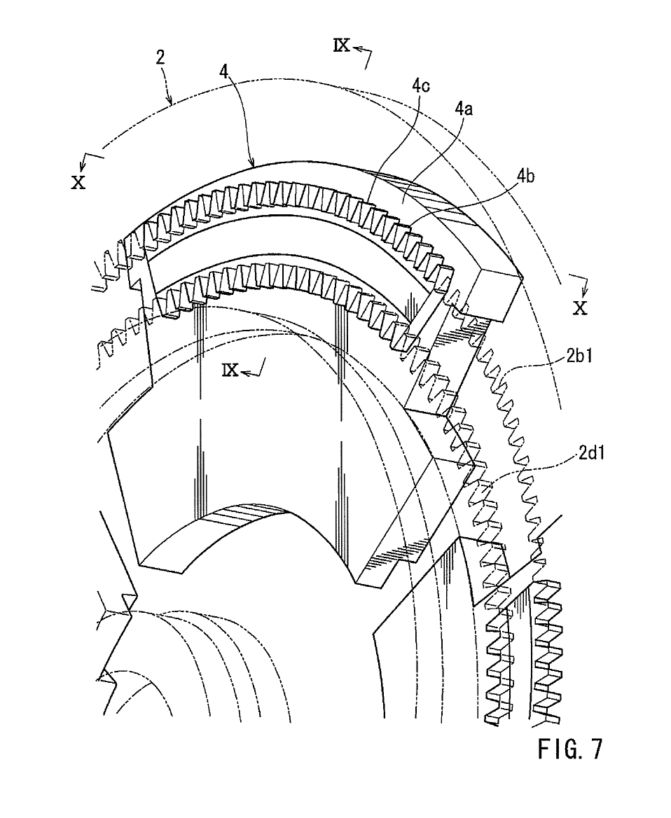

The projection 4b extends in an arc shape along an external periphery of the lock main body 4a as shown in FIGS. 4 and 7. The projection 4b has an external peripheral surface on the outer side of the arc radial direction. The external peripheral surface faces externally in the radial direction. A plurality of external teeth 4c are formed in the external peripheral surface at the same interval. Each external tooth 4c extends axially. The projection 4b has an internal peripheral surface on the center side of the arc radial direction. The internal peripheral surface faces toward the center of the radial direction. A plurality of internal teeth 4d are formed in the internal peripheral surface at the same interval. Each internal tooth 4d extends axially.

A biasing member 8 is provided between the lock member 4 and the second member 3 as shown in FIGS. 4 and 5. The biasing member 8 is a flat spring that is provided with an annular base 8a and a plurality of elastic sections 8b extending from the base 8a. A hole 8d is formed at the center of the base 8a. The elastic sections 8b extend radially from the base 8a toward the lock member 4. The elastic sections 8b contact the lock member 4 in a state where the elastic sections 8b are elastically deformed, and thereby the lock member 4 is biased against the first member 2.

As shown in FIGS. 4 and 5, the angle adjustment apparatus 1 has a movement mechanism 15 at the axial center thereof. The movement mechanism 15 axially moves the lock member 4. The movement mechanism 15 has an input member 5, a drive member (drive bush) 6, and the controlling plate 7.

The input member 5 is integrally provided with a main body 5a, a projection 5c, and a flange 5b as shown in FIGS. 3 and 5. The main body 5a has a column shape, and is provided with an engagement portion 5d, 5e (male thread) in its external peripheral surface. The projecting spiral 5d is projection-shaped, and the groove-shaped spiral 5e is groove-shaped. The engagement portion 5d, 5e extend in a spiral shape so as to be screwed into other engagement portion 6d, 6e (female thread) of the drive member 6.

The flange 5b extends radially externally from the main body 5a as shown in FIGS. 4 and 5, and the flange 5b is axially adjacent to the second member 3. The main body 5a penetrates the second member 3 and the first member 2. A washer 16 and an anti-drop member 17 are attached to the tip end portion of the main body 5a. The washer 16 is rotatably attached to the main body 5a and contacts the first member 2. The anti-drop member 17 is fixed to the main body 5a, and cooperates with the washer 16 to regulate the input member 5 from being dropped out of the first member 2 in the axial direction. Thus, the input member 5 is regulated from being axially moving with respect to the first member 2 and the second member 3 by the anti-drop member 17 and the flange 5b, while the input member 5 is axially rotatable.

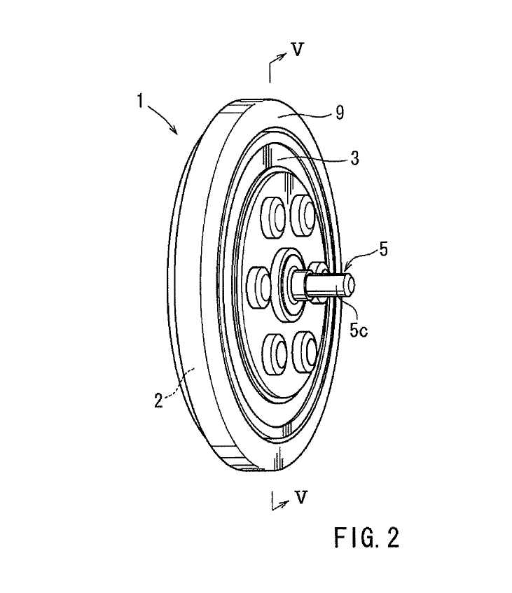

The projection 5c of the input member 5 axially extends from the flange 5b, as shown in FIGS. 2 and 5. A lever 14, shown in FIG. 1, is connected to the projection 5c. The lever 14 extends forward from the projection 5c such that the front end portion of the lever 14 is adjacent to a user seated on the vehicle seat 10. Lifting the front end portion of the lever 14 rotates the input member 5 and changes the angle adjustment apparatus 1 from a locked state to an unlocked state.

The drive member 6 is integrally provided with a main body 6a, an end portion 6c, and a flange 6b, as shown in FIGS. 4 and 5. The main body 6a has a tubular shape, and is provided with an engagement portion 6d, 6e (female thread) in an internal peripheral surface of the main body 6a. The groove-shaped spiral 6d is groove-shaped, and the projecting spiral 6e is projection-shaped. The engagement portion 6d, 6e extend in a spiral shape so as to be screwed into the engagement portion 5d, 5e of the input member 5.

The main body 6a is inserted into the controlling plate 7, the biasing member 8, and the second member 3, as shown in FIGS. 4 and 5. The external peripheral surface of the main body 6a has a non-circular cross section, and has a rotation regulation surface 6a1. The rotation regulation surface 6a1 is provided so as to oppose rotation regulation portions 7c, 8c, and 3g which are formed on the periphery of the holes 7b, 8d, and 3e of the controlling plate 7, the biasing member 8, and the second member 3, respectively. With this, the drive member 6 is regulated from axially rotating with respect to the controlling plate 7, the biasing member 8, and the second member 3.

The flange 6b projects radially from the main body 6a so as to be axially adjacent to the controlling plate 7, as shown in FIGS. 4 and 5. The end portion 6c axially extends from the main body 6a toward the first member 2. The end portion 6c has a cylindrical shape, and is axially rotatably provided to the hole 2f of the first member 2. When the lock member 4 moves axially from the first member 2 toward the second member 3, the flange 6b pushes the controlling plate 7, thereby causing the controlling plate 7 to space the lock member 4 from the first member 2. With this, the teeth of the lock member 4 (the external teeth 4c and the internal teeth 4d) are spaced apart from the teeth of the first member (the internal teeth 2b1 and the external teeth 2d1).

The controlling plate 7 has a disc-shaped main body 7a as shown in FIGS. 3 and 4. The main body 7a is provided between the first member 2 and each lock member 4. A claw 7d and a projection 7f are formed in a surface of the main body 7a facing the lock member 4. The claw 7d passes a side of the lock member 4 from the main body 7a, and latches onto a recess 4a1 formed in the opposite surface of the lock member 4. The projection 7f projects from the main body 7a toward the lock member 4 to be inserted into a recess 4f of the lock member 4. With this, the controlling plate 7 and the lock member 4 are regulated from axially rotating with respect to each other.

A retaining ring 9 is provided in an external periphery of the angle adjustment apparatus 1 so as to prevent the first member 2 and the second member 3 from dropping in the axial direction, as shown in FIG. 2. The retaining ring 9 is integrally provided with a ring main body 9a, a first projecting portion 9b, and a second projecting portion 9c. The ring main body 9a has a cylindrical shape, and covers the external peripheral surface of the first member 2 and the external peripheral surface of the second member 3.

The first projecting portion 9b has an annular shape as shown in FIGS. 4 and 5, and projects from one end portion of the axial direction of the ring main body 9a toward the center of the radial direction. The first projecting portion 9b is axially adjacent to the first member 2, and regulates the first member 2 from moving in a direction away from the second member 3. The second projecting portion 9c has an annular shape, and projects from the other end portion of the axial direction of the ring main body 9a toward the center of the radial direction. The second projecting portion 9c is axially adjacent to the second member 3, and regulates the second member 3 from moving in a direction away from the first member 2.

The angle adjustment apparatus 1 is normally in the locked state as shown in FIG. 5. In the locked state, the biasing member 8 biases the lock member 4 against the first member 2. The external teeth 4c of the lock member 4 are engaged with the internal teeth 2b1 of the first member 2, and the internal teeth 4d of the lock member 4 are engaged with the external teeth 2d1 of the first member 2. Since the lock member 4 is regulated from rotating with respect to the second member 3, the first member 2 and the second member 3 are regulated from rotating by the lock member 4. With this, as shown in FIG. 1, the first seat member 11a and the second seat member 12a are regulated from rotating by the angle adjustment apparatus 1.

In order to unlock the angle adjustment apparatus 1 in the locked state, the front end portion of the lever 14 is lifted upward as shown in FIG. 1. The lever 14 then axially rotates the input member 5, and the input member 5 is axially rotated with respect to the drive member 6, as shown in FIG. 5. The engagement portion 5d, 5e of the input member 5 axially pushes the engagement portion 6d, 6e, thereby causing the drive member 6 to axially move from the first member 2 toward the second member 3.

As shown in FIGS. 3 and 5, the flange 6b of the drive member 6 pushes the controlling plate 7, and the controlling plate 7 pushes the lock member 4 toward the second member 3 against the biasing force of the biasing member 8. The external teeth 4c and the internal teeth 4d of the lock member 4 are axially disengaged from the internal teeth 2b1 and the external teeth 2d1 of the first member 2. With this, the first member 2 becomes axially rotatable with respect to the lock member 4, and the first member 2 becomes axially rotatable with respect to the second member 3. Consequently, the first seat member 11a can be angle-adjusted with respect to the second seat member 12a as shown in FIG. 1.

When the force exerted on the lever 14 is released, the biasing member 8 pushes the lock member 4 toward the first member 2, as shown in FIG. 5. The lock member 4 is engaged with the first member 2, and the angle adjustment apparatus 1 is then returned from the unlocked state to the locked state. When the seat back 11 is tilted forward more than a predetermined angle, however, the projection pins 2g of the first member 2 are not inserted into the elongated grooves 7e of the controlling plate 7 as shown in FIG. 3, thereby contacting the controlling plate 7. The controlling plate 7 regulates the lock member 4 from being engaged with the first member 2. Accordingly, the angle adjustment apparatus 1 is maintained in the unlocked state, and the seat back 11 can be angle-adjusted with respect to the seat cushion 12.

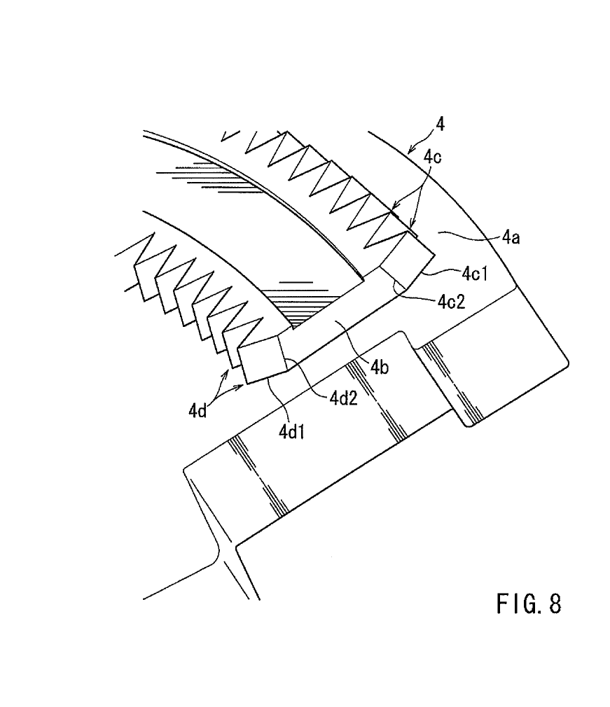

As shown in FIGS. 7 and 8, the lock member 4 is engaged with the first member 2 in the locked state, so as to receive a force from the first member 2. This force can be received after distributed into shearing forces of first regions 4c1, 4d1 and second regions 4c2, 4d2 of the lock member 4. The first regions 4c1, 4d1 are a boundary region between the teeth (the external teeth 4c and the internal teeth 4d) and the lock main body 4a. The second regions 4c2, 4d2 are a boundary region between the main body of the projection 4b and the teeth (the external teeth 4c and the internal teeth 4d).

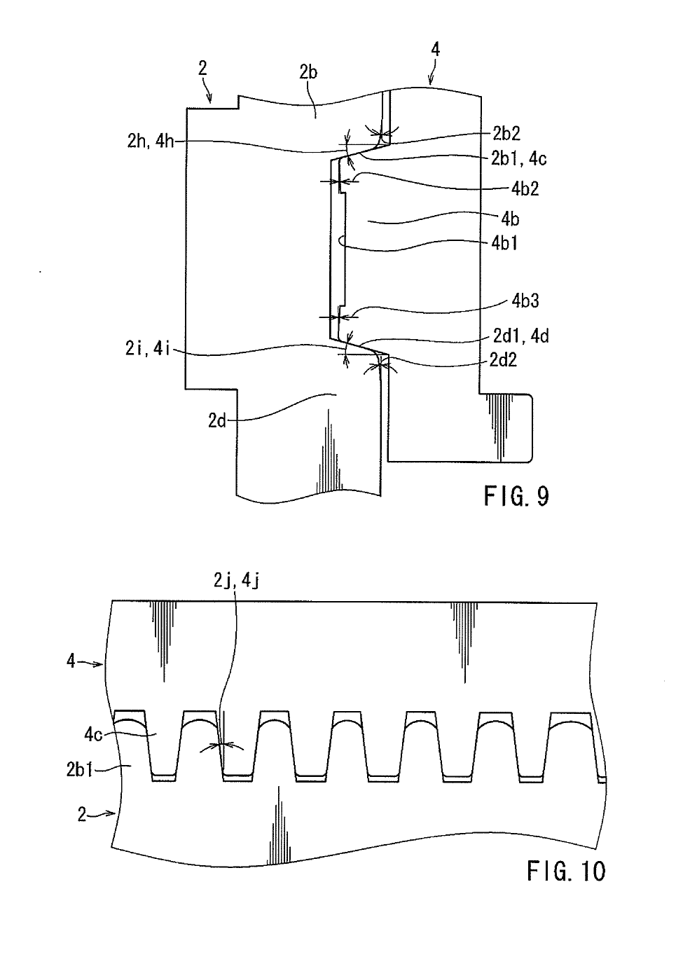

As shown in FIG. 9, the first member 2 and the lock member 4 are provided with first tapered portions 2h, 4h and second tapered portions 2i, 4i. The first tapered portion 2h is formed in the internal teeth 2b1 of the first member 2, and inclines the internal teeth 2b1 such that the tip end portion of the internal teeth 2b1 is farther away from the axial center than the base end portion thereof. The first tapered portion 4h of the lock member 4 is formed in the external teeth 4c, and inclines the external teeth 4c such that the tip end portion of the external teeth 4c is closer to the axial center than the base end portion thereof. The first tapered portions 2h, 4h are set to be at 10° or less such as 3-10°, for example 6.5° with respect to the axis line. Consequently, the internal teeth 2b1 and the external teeth 4c can surely be engaged with each other because they are guided by the first tapered portions 2h, 4h when their positions displace in the radial direction.

As shown in FIG. 9, the second tapered portion 2i is formed in the external teeth 2d1 of the first member 2, and inclines the external teeth 2d1 such that the tip end portion of the external teeth 2d1 is closer to the axial center than the base end portion thereof. The second tapered portion 4i of the lock member 4 is formed in the internal teeth 4d, and inclines the internal teeth 4d such that the tip end portion of the internal teeth 4d is farther away from the axial center than the base end portion thereof. The second tapered portions 2i, 4i are set to be at 10° or less such as 3-10°, for example 6.5° with respect to the axis line. Consequently, the external teeth 2d1 and the internal teeth 4d can surely be engaged with each other because they are guided by the second tapered portions 2i, 4i when their positions displace in the radial direction.

Guiding tapered portions 2b2, 2d2 are provided in the first member 2 as shown in FIG. 9. The guiding tapered portion 2b2 is formed in the ring main body 2b so as to be adjacent to the outside of the internal teeth 2b1 in the radial direction. The guiding tapered portion 2b2 is inclined from a surface of the ring main body 2b facing the lock member 4 toward the base portion of the internal teeth 2b1. The guiding tapered portion 2d2 is formed in the annular portion 2d so as to be adjacent to the center side of the external teeth 2d1 in the radial direction. The guiding tapered portion 2d2 is inclined from a surface of the annular portion 2d facing the lock member 4 toward the base portion of the external teeth 2d1. The guiding tapered portions 2b2, 2d2 are set to be at 10-20°, for example, 16° with respect to a plane perpendicular to the axis line. Consequently, the first member 2 and the lock member 4 can surely be engaged with each other because they are guided by the guiding tapered portions 2b2, 2d2 when their positions displace significantly in the radial direction.

A groove 4b1 and tapered surfaces 4b2, 4b3 are formed in a surface of the projection 4b of the lock member 4 facing the first member 2 as shown in FIG. 9. The groove 4b1 is formed in a central area of the projection 4b in the radial direction, and extends circumferentially. The tapered surface 4b2 is located between the external teeth 4c and the groove 4b1, and is inclined from the end portion of the external teeth 4c toward the bottom of the groove 4b1. The tapered surface 4b3 is located between the internal teeth 4d and the groove 4b1, and is inclined from the end portion of the internal teeth 4d toward the bottom of the groove 4b1. The tapered surfaces 4b2, 4b3 are set to be at 1-5° (for example, 3°) with respect to a plane perpendicular to the axis line. Consequently, the end portion of the projection 4b hardly contacts the first member 2, thereby allowing the first member 2 and the lock member 4 to surely be engaged with each other in the axial direction.

As shown in FIG. 10, the internal teeth 2b1 of the first member 2 and the external teeth 4c of the lock member 4 axially extend in a state of being tapered. The both surfaces of the internal teeth 2b1 and the external teeth 4c have tapered angles 2j, 4j with respect to the axis line. By the tapered angles, the internal teeth 2b1 and the external teeth 4c are engaged with each other easily in the axial direction. Although it is omitted in the drawings, the external teeth 2d1 of the first member 2 and the internal teeth 4d of the lock member 4 also axially extend in a state of being tapered. The both surfaces of the external teeth 2d1 and the internal teeth 4d have tapered angles with respect to the axis line. By the tapered angles, the external teeth 2d1 and the internal teeth 4d are engaged with each other easily in the axial direction.

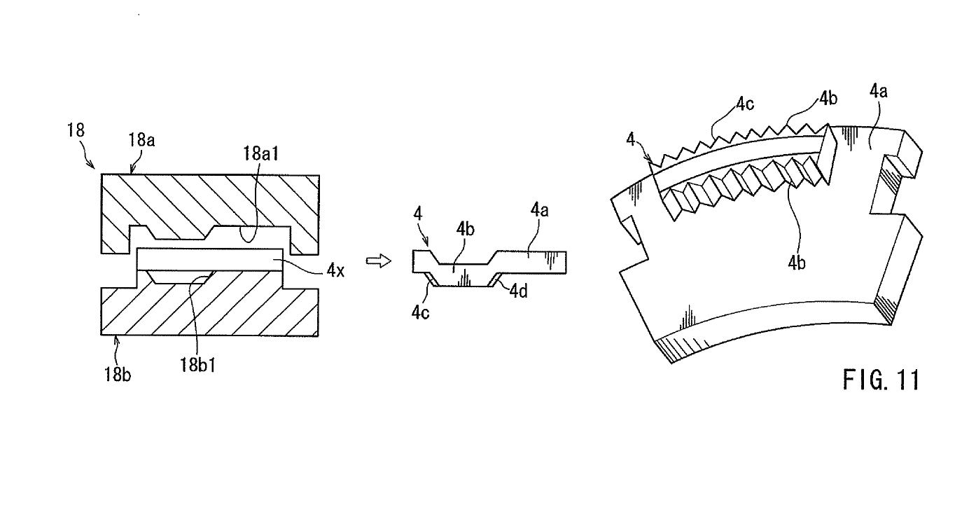

As shown in FIG. 11, the lock member 4 is formed by a forming die 18. In order to form the lock member 4, a plate member 4x before forming is provided between an upper die 18a and a lower die 18b of the forming die 18. When the plate member 4x is pressed by closing the upper die 18a and the lower die 18b, the lock member 4 is formed by a cavity 18a1 of the upper die 18a and a cavity 18b1 of and the lower die 18b. The external teeth 4c and the internal teeth 4d extend in the clamping direction of the upper die 18a and the lower die 18b. Even if press is insufficient, therefore, the top portion and the bottom portion of the external teeth 4c and the internal teeth 4d can surely be formed.

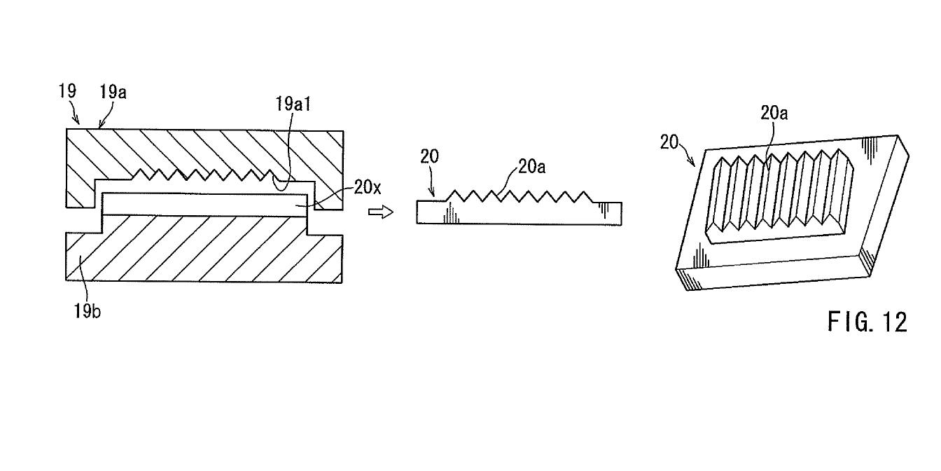

In contrast, as shown in FIG. 12, a comparative lock member 20 is formed by a forming die 19. In order to form the comparative lock member 20, a plate member 20x before forming is provided between an upper die 19a and a lower die 19b of the forming die 19. When the plate member 20x is pressed by closing the upper die 19a and the lower die 19b, the lock member 20 is formed by a cavity 19a1 of the upper die 19a. A tooth 20a of the lock member 20 extends in a direction perpendicular to the clamping direction of the upper die 19a and the lower die 19b. If press is insufficient, therefore, there are cases where the top portion and the bottom portion of the tooth 20 may not finely be formed.

As described above, the angle adjustment apparatus 1 has the first member 2, the second member 3, the lock member 4, and the movement mechanism 15 as shown in FIGS. 3 and 4. The first member 2 is attached to the first seat member 11a (see FIG. 1). The second member 3 is attached to the second seat member 12a (see FIG. 1) and rotatably mounted to the first member 2. The lock member 4 is axially movably provided between the first member 2 and the second member 3. The movement mechanism 15 is provided to axially move the lock member 4 with respect to the first member 2. The second member 3 has the rotation regulation portions 3b that allows the lock member 4 to axially move and regulates the lock member 4 from circumferentially moving. The first member 2 has a plurality of internal teeth 2b1 formed in an annular-shaped internal peripheral surface. The lock member 4 has an external peripheral surface facing substantially externally in the radial direction and facing the internal peripheral surface of the first member 2, and a plurality of external teeth 4c formed in the external peripheral surface to be engaged with the internal teeth 2b1 of the first member 2 by axially moving.

Accordingly, since the external teeth 4c are formed in the external peripheral surface of the lock member 4 facing substantially externally in the radial direction, each of the external teeth 4c extends axially. Thus, the interval of the external teeth 4c is almost unchanged over the entire length, and the interval of the teeth is not narrow (small) on the center side of the radial direction, differently from, for example, a case of teeth that extend radially. Likewise, since the internal teeth 2b1 of the first member 2 extend substantially axially, the interval of the internal teeth is not greatly changed over the entire length. Accordingly, the external teeth 4c of the lock member 4 and the internal teeth 2b1 of the first member 2 can be formed accurately.

The external teeth 4c of the lock member 4 have the tapered portion 4h inclined with respect to the axis line and facing the first member 2 as shown in FIG. 9. The angle size of the tapered portion 4h is 10° or less with respect to the axis line. Since the tapered portion 4h is small, the external teeth 4c face substantially externally in the radial direction. Further, since the tapered portion 4h is small, the external teeth 4c can be engaged with the internal teeth 2b1 of the first member 2 gradually deeply by axially moving the lock member 4 toward the first member 2. In this manner, the external teeth 4c can surely and easily be engaged with the internal teeth 2b1.

As shown in FIGS. 3 and 4, a plurality of lock members 4 are provided circumferentially around the axial center. Each lock member 4 is engaged with the first member 2. Thus, the lock members 4 easily move circumferentially compared to a case where a single large annular lock member extending around the axial center is engaged with the first member. Each lock member 4 can, therefore, easily be engaged with the first member 2 without being affected by other lock members 4.

The first member 2 has the annular portion 2d that is located closer to the axial center side than the internal teeth of the first member 2; and a plurality of external teeth 2d1 formed in the external peripheral surface of the annular portion 2d, as shown in FIGS. 3 and 4. The lock member 4 has an internal peripheral surface facing the external peripheral surface of the annular portion 2d and facing substantially toward the center of the radial direction; and a plurality of internal teeth 4d formed in the internal peripheral surface of the lock member 4 to be engaged with the external teeth 2d1 of the first member 2 by axially moving.

With this, the lock member 4 is engaged with the first member 2 in the internal peripheral surface as well as the external peripheral surface. The lock member 4 can, therefore, securely be engaged with the first member 2. Further, since the internal teeth 4d of the lock member 4 are formed in the internal peripheral surface of the lock member 4 facing substantially toward the center of the radial direction, each of the internal teeth 4d extends axially. Thus, the interval of the internal teeth 4d is almost unchanged over the entire length, and the interval of the teeth is not narrow (small) on the center side of the radial direction, differently from, for example, a case of teeth that extend radially. Likewise, since the external teeth 2d1 of the first member 2 extend substantially axially, the interval of the internal teeth is not greatly changed over the entire length. Accordingly, the internal teeth 4d of the lock member 4 and the external teeth 2d1 of the first member 2 can be formed accurately.

The internal teeth 4d of the lock member 4 has the tapered portion 4i inclined with respect to the axis line and facing the first member 2 as shown in FIG. 9. The angle size of the tapered portion 4i is 10° or less with respect to the axis line. Since the tapered portion 4i is small, the internal teeth 4d face substantially toward the center of the radial direction. Further, since the tapered portion 4i is small, the internal teeth 4d can be engaged with the external teeth 2d1 of the first member 2 gradually deeply by axially moving the lock member 4 toward the first member 2. In this manner, the internal teeth 4d can surely and easily be engaged with the external teeth 2d1.

The lock member 4 has the plate-shaped lock main body 4a, and the projection 4b that projects from the lock main body 4a in a plate thickness direction and extends in an arc shape, as shown in FIG. 4. The external teeth 4c are formed in the external peripheral surface of the projection 4b on the outer side of the arc radial direction. The projection 4b in which the external teeth 4c are formed is reinforced by the lock main body 4a with respect to an end portion thereof.

As shown in FIG. 4, the internal teeth 4d are formed in the internal peripheral surface of the projection 4b on the center side of the arc radial direction. The internal teeth 4d are formed in the projection 4b in the same manner as the external teeth 4c, and the projection 4b is reinforced by the lock main body 4a.

Each of the external teeth 4c extends in the clamping direction of the forming die 18 for forming the lock member 4 as shown in FIG. 11. Therefore, when the lock member 4 is press-formed by the forming die 18, the top portion and the bottom portion of the external teeth 4c can surely be formed even if a press force is insufficient.

The present invention is not limited to the above-described embodiments, but may be embodied in forms below. For instance, in another embodiment, the first member 2 may be attached to the cushion frame (first seat member) 12a, and the second member 3 may be attached to the back frame (second seat member) 11a.

In another embodiment, the vehicle seat may have a seat back as one of the first seat member and the second seat member, and may have an arm rest or a table as the other of the first seat member and the second seat member. In another embodiment, the vehicle seat may have a seat cushion as one of the first seat member and the second seat member, and may have a foot rest to support occupant's calves as the other of the first seat member and the second seat member.

In another embodiment, the first member 2 may not have the external teeth 2d1, and the lock member 4 may not have the internal teeth 4d. In another embodiment, the internal teeth 2b1 of the first member 2 may not have the tapered angle 2j, and the external teeth 4c of the lock member 4 may not have the tapered angle 4j.

In another embodiment, the angle adjustment apparatus 1 may have one to three pieces of the lock members 4, or five or more pieces of the lock members 4. In another embodiment, the angle adjustment apparatus 1 may have a single annular lock member that extends around the axis. In another embodiment, the lock member 4 may not have the projection 4b, and may have external teeth in the external peripheral surface of the lock main body 4a.

The angle pitch of the external teeth 4c and the angle pitch of the internal teeth 4d are set to be identical in the above-described embodiments. However, the angle pitch of the external teeth 4c may be different from the angle pitch of the internal teeth 4d. For instance, the angle pitch of the internal teeth 4d may be set to be greater than the angle pitch of the external teeth 4c, thereby increasing the circumferential pitch of the internal teeth 4d.

The vehicle seat 10 of FIG. 1 is mounted to a vehicle such as an automobile, but may also be mounted to a boat, an airplane, and the like.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above-described embodiments, and various variations and modifications may be possible without departing from the scope of the present invention.

What is claimed is:

1. An angle adjustment apparatus for a vehicle seat, the apparatus angle-adjustably connecting a first seat member and a second seat member of the vehicle seat, the apparatus comprising:
a first member attached to the first seat member;
a second member attached to the second seat member and rotatably mounted to the first member;
a lock member axially movably provided between the first member and the second member; and
a movement mechanism that axially moves the lock member with respect to the first member, wherein
the second member has a rotation regulation portion that allows the lock member to axially move and regulates the lock member from circumferentially moving;
the first member has a plurality of internal teeth formed in an annular-shaped internal peripheral surface; and
the lock member has an external peripheral surface facing substantially externally in a radial direction and facing the internal peripheral surface of the first member, and a plurality of external teeth formed in the external peripheral surface to be axially moved relative to and engaged with the internal teeth of the first member.

2. The angle adjustment apparatus for a vehicle seat according to claim 1, wherein the external teeth of the lock member have a tapered portion that is inclined with respect to an axis line and faces the first member, and the angle size of the tapered portion is 10° or less with respect to the axis line.

3. The angle adjustment apparatus for a vehicle seat according to claim 1, wherein the lock member comprises a plurality of lock members that are provided circumferentially around the axial center.

4. The angle adjustment apparatus for a vehicle seat according to claim 1, wherein
the first member has an annular portion that is located closer to the axial center side than the internal teeth of the first member, and a plurality of external teeth formed in an external peripheral surface of the annular portion; and
the lock member has an internal peripheral surface facing the external peripheral surface of the annular portion and facing substantially toward the center of the radial direction, and a plurality of internal teeth formed in the internal peripheral surface of the lock member to be axially moved relative to and engaged with the external teeth of the first member.

5. The angle adjustment apparatus for a vehicle seat according to claim 4, wherein the internal teeth of the lock member have a tapered portion that is inclined with respect to the axis line and faces the first member, and the angle size of the tapered portion is 10° or less with respect to the axis line.

6. The angle adjustment apparatus for a vehicle seat according to claim 1, wherein:
the lock member has a plate-shaped lock main body, and a projection that projects from the lock main body in a plate thickness direction and extends in an arc shape; and
the external teeth are formed in an external peripheral surface of the projection on the outer side of the arc radial direction.

7. The angle adjustment apparatus for a vehicle seat according to claim 4, wherein:
the lock member has a plate-shaped lock main body, and a projection that projects from the lock main body in a plate thickness direction and extends in an arc shape; and
the internal teeth are formed in an internal peripheral surface of the projection on the center side of the arc radial direction.

8. The angle adjustment apparatus for a vehicle seat according to claim 1, wherein each of the external teeth extends in a clamping direction of a forming die for forming the lock member.
